(19) United States
(12) Patent Application Publication
(10) Pub. No.: US 2010/0107902 A1
(43) Pub. Date: May 6, 2010

(54) Kitchen injector

(75) Inventor: Eric J. Wangler, Mendon, NY (US)

Correspondence Address: LAW OFFICE OF JOHN C. MCMAHON, P.O. BOX 30069, KANSAS CITY, MO, 64112, US

(73) Assignee: Mary P. Crowley-Wangler, Mendon, NY (US)

(21) Appl. No.: 12/291,092

(22) Filed: Nov. 6, 2008

(51) Int. Cl. A47J 43/00

(52) U.S. Cl. 99/532

(57) ABSTRACT

A cooking fluid injector including a barrel with a plunger operably moved by a trigger. The amount of movement of the trigger is controlled by a selector switch that provides for a preselected ejection of fluid with each depression of the trigger.

### CROSS-REFERENCE TO RELATED APPLICATIONS

This application claims the benefit of U.S. Provisional Application No. 60/002,642 filed Nov. 9, 2007, incorporated by reference herein.

### BACKGROUND OF THE INVENTION

The present invention is directed to a device for injecting fluids into foodstuff, especially meat, prior to cooking.

Chefs often encounter situations where additional fluid is required in cooking foods, especially meats, or such fluids are beneficial to the process or carry added ingredients such as seasonings, marinades, broths and the like.

Many chefs also like to be able to control the addition of fluid in order to add the same amount each time they cook a particular cut of meat or the like or they want to be able to accurately keep track of the amount of total fluid added.

The present invention is designed to allow a chef to both easily inject fluid into food being cooked and to control the specific amount being injected. The invention also allows the amount injected to be easily varied with each injection.

### SUMMARY OF THE INVENTION

A fluid injector for injecting cooking fluids into foods, especially meats. The injector include a barrel for holding the fluid to be injected that receives a plunger at one end and terminates in a thin hollow tube at the opposite end. The tube has apertures or outlets spaced therealong to allow exit of the fluid from the tube at multiple axially spaced sites.

The injector includes a handle attached to the barrel and a trigger that is pivotally attached to the handle and biased to a forward position by a spring.

The plunger is secured to an actuator that extends generally axially and rearwardly from the plunger. The actuator has a series of spaced teeth forming a linear ratchet like structure on the underside thereof.

The trigger has a pivotal pawl at the top thereof that selectively engages the teeth of the ratchet. The pawl has a rearward extending thumb release. The position of the pawl along the ratchet, when the trigger is in the forward position, is controlled by a selector switch on the rear of the injector. In particular, the trigger has a rearward arm projecting from the upper end thereof. The arm engages different abutments or structures of the switch which in turn limits the amount that the trigger can be depressed. In this way, when a particular position is chosen and the trigger is fully depressed to a rearward position thereof, the pawl acting through the ratchet propels the activator and plunger forward a preselected distance to eject a preselected amount of fluid through the tube (for example, one eighth, one fourth or one half ounce) depending upon the selected position of the switch. Thus, a preselected amount of fluid is ejected with each full depression of the trigger.

### OBJECTS AND ADVANTAGES OF THE INVENTION

Therefore, the objects of the invention are: to provide a cooking fluid injector that allows a user to inject a preselected quantity of fluid into food, especially meat, with each complete depression of a trigger; to provide such an injector wherein the amount of fluid injected can be easily varied; and to provide such an injector that is easy to use, inexpensive to produce and especially well suited for the intended purpose thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a fluid injector in accordance with the present invention.

FIG. 2 is a top plan view of the injector.

FIG. 3 is a side elevational view of the injector.

FIG. 4 is a cross sectional view of the injector, taken along line 4-4 of FIG. 2.

FIG. 5 is a rear elevational view of the injector.

FIG. 6 is a front elevational view of the injector.

FIG. 7 is a fragmentary cross sectional view of the injector similar to FIG. 4, showing the injector set so as to have ejected a first quantity of fluid.

FIG. 8 is a fragmentary cross sectional view of the injector similar to FIG. 4, showing the injector set so as to have ejected a second quantity of fluid.

FIG. 9 is a cross sectional view of the injector similar to FIG. 4, showing the injector set so as to have ejected a third quantity of fluid.

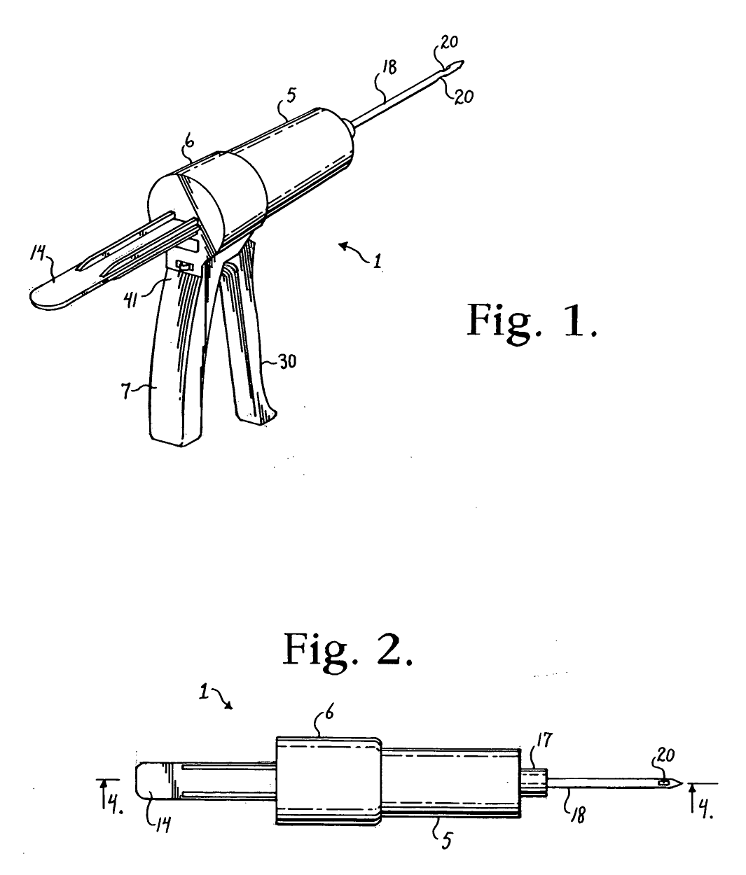

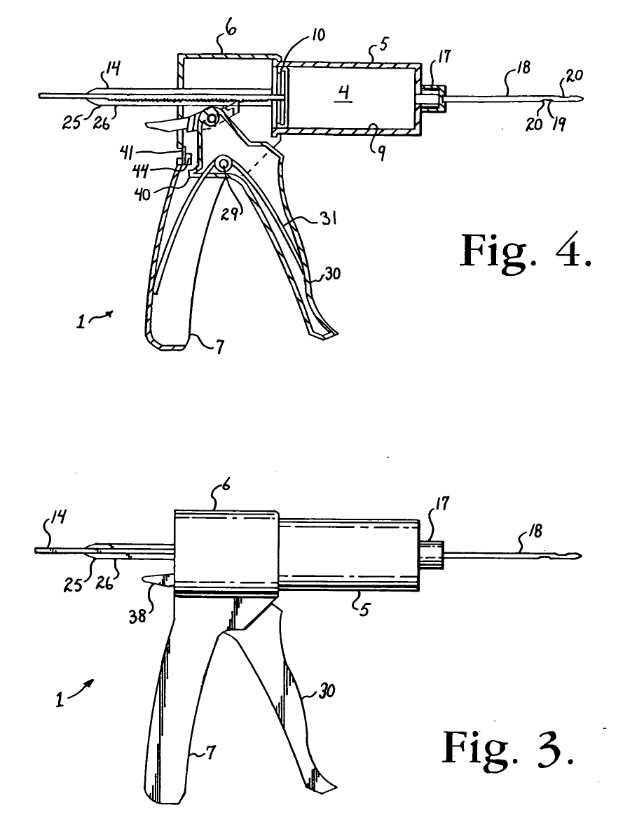

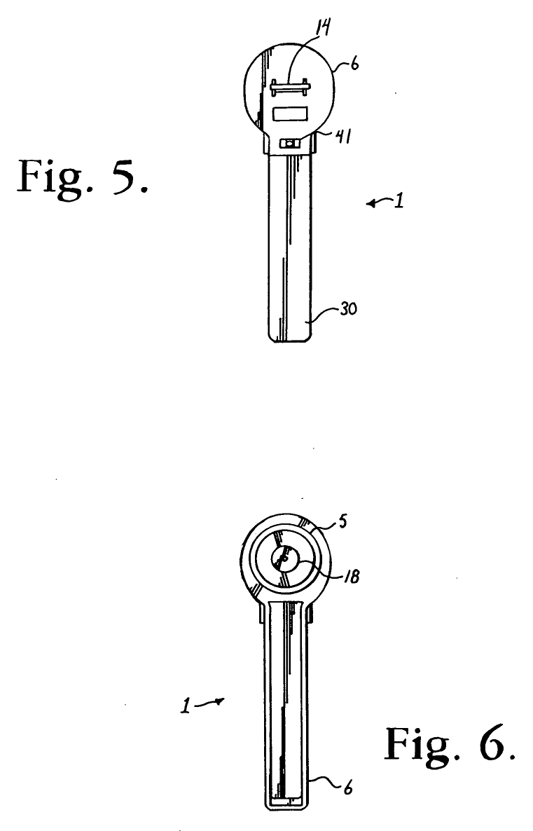

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally indicates a cooling fluid injector in accordance with the present invention for injecting cooking fluids 4 into foodstuff, especially meat. Various liquids can be used with the injector including liquids with seasoning mixed into the fluid, marinades, broth or the like.

The injector 1 includes a barrel 5 joined by a frame 6 to a handle 7. The barrel 5 has a cylindrical shaped interior cavity 9 and is constructed so as to hold the fluids 4. A plunger 10 is received in and is coaxially aligned with the barrel 5. The plunger 10 is sized to seal with the side walls of the cylindrical cavity 9. A rear of the barrel 5 has an opening 12 that slidably receives an actuator 14. The actuator 14 is joined at a front end to the plunger 10 and axially aligned with the barrel 5.

The front of the barrel 5 has a forward and axially aligned outlet 17 that flow communicates with the cavity 9. Mounted on the outlet 17 is a thin elongate tube 18 that flow communicates with the outlet 17 to receive fluid from the cavity 9 into an interior passageway 19 thereof.

Located along the tube 18 are a series of axially spaced openings apertures or outlets 20, especially near the front end of the tube 18 that flow communicate with the passageway 19.

The actuator 14 extends rearward of the barrel 5 and has a ratchet like structure 25 with a plurality of evenly spaced teeth 26 extending axially along the underside of the actuator 14.

Mounted on the handle 7 by a pivot 29 is a trigger 30. The trigger 30 has a forward position seen in FIG. 4 and a rearward position that is seen in FIG. 9. The trigger 30 is biased to the forward position by a spring 31.

Pivotally mounted near the top of the trigger 30 is a pawl 35. The pawl 35 has a forward engagement end 36 that is received against the ratchet teeth 27 and a rearward thumb release 38.

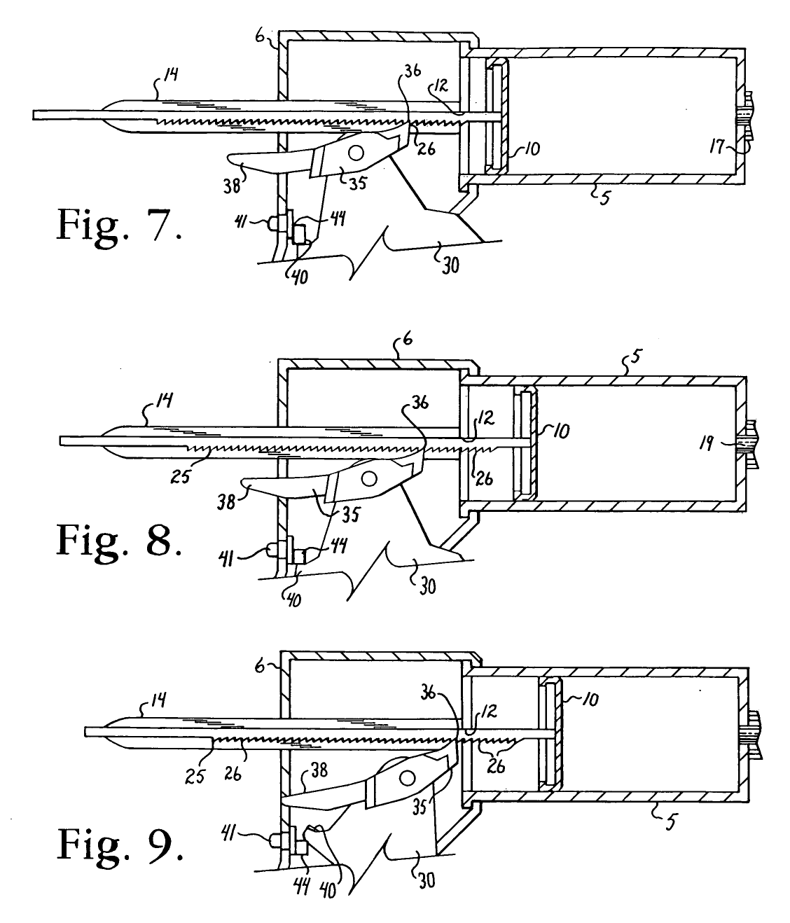

Also mounted on and extending rearward of the trigger 30 is a stop or positioning arm 40. Mounted on the rear of the handle 7 is a selector switch 41. The selector switch 41 has three positions: left, center and right. When in each of the positions there is an abutment structure 44 on the switch that engages or does not engage the arm 40. The left position engages the arm 40 in such a way as to limit forward movement of the trigger 30 such that the pawl 35 pushes the actuator 14 and plunger 10 only a first distance that ejects a first quantity of the fluid 4 (for example, one eighth ounce), as seen in FIG. 7. When in the second position, the trigger 30, when fully depressed, is limited so that the pawl 35 pushes the actuator 14 and plunger 10 to a second position that ejects a second greater quantity of the fluid 4 (for example, one fourth ounce), as seen in FIG. 8. When the switch 41 is in the third position, the trigger 30, when fully depressed, can depress to its full range and the pawl 35 pushes the actuator 14 and plunger 10 to a third position relative to the barrel 5 that ejects a third still greater quantity of the fluid 4 from the barrel 5 (For example, one half ounce), as seen in FIG. 9.

When released, the trigger 30 returns to the forward position and the pawl 35 is positioned the same number of teeth 26 from the barrel 5 with each repetition, although the number of teeth 26 that move forward with each depression of the trigger 30 depends on the setting of the switch 41.

In use the tube 18 is inserted into meat or other foodstuff and the trigger 30 is depressed to inject the liquid 4 into the foodstuff.

It is to be understood that while certain forms of the present invention have been illustrated and described herein, it is not to be limited to the specific forms or arrangement of parts described and shown.

What is claimed and desired to be secured by Letters Patent is as follows:

1. A cooking fluid injector comprising:
a) a barrel having a cylindrical shaped inner cavity adapted to receive cooking fluid for injecting;
b) an elongate thin tube joined to the front of the barrel and having a passageway flow communicating with the barrel chamber and at least one distribution outlet therealong;
c) a plunger mounted in the chamber and being movable axially along the chamber;
d) an actuator joined to said plunger and extending rearwardly from the barrel; the actuator having a ratchet mechanism with a plurality of generally evenly spaced teeth on a bottom side of the actuator;
e) a handle attached to the barrel; and
f) a trigger pivotally mounted with respect to the handle; the trigger having a pawl mounted near an upper end thereof; the pawl operably engaging the teeth of the ratchet mechanism when the trigger is depressed so as to bias the actuator and plunger forward relative to the barrel and eject fluid from the chamber.

2. The injector according to claim 1 including:
a) a rearwardly projecting positioning arm on the trigger; and
b) a selector switch having a plurality of selective positions wherein each position presents structure having a different stop configuration to the trigger, so as to control the amount of movement of the trigger upon depression of the trigger and subsequently, the amount of fluid ejected from the chamber.

3. The injector according to claim 2 wherein:
a) the dispensing outlet is a first outlet and the tube includes at least one additional dispensing outlet axially spaced from the first dispensing outlet.
